(19) United States
(12) Patent Application Publication
(10) Pub. No.: US 2011/0267732 A1
(43) Pub. Date: Nov. 3, 2011

(54) CIRCUIT PROTECTIVE DEVICE

(76) Inventor: SAMUEL KUO, Guishan Township (TW)

(21) Appl. No.: 12/772,794

(22) Filed: May 3, 2010

(51) Int. Cl. H02H 5/04

(52) U.S. Cl. 361/104

(57) ABSTRACT

A circuit protective device has a wire-wound resistor, a fuse and a voltage limiter connected by welding, and may be covered by a protective housing possibly filled with a filling material. The resistor withstands an incoming transient voltage and reduces a surge current through the voltage limiter to realize a more compact and inexpensive voltage limiter without compromising the surge protective capability. The voltage limiter clamps the incoming transient voltage to a specified level. When the wire-wound resistor or the voltage limiter is overheated by to a surge voltage which is higher than the surge voltage withstanding rating of this circuit protective device, either the wire-wound resistor melts down or the fuse opens to disconnect the electronic circuit from the AC mains against subsequent surges. Accordingly, the circuit protective device addresses a cost-saving, compact, robust and safe solution against surge voltages, surge currents and sustained voltages.

### BACKGROUND OF THE INVENTION

1. Field of the Invention

The present invention is related to a circuit protective device, and more particularly to a circuit protective device having a wire-wound resistor, a fuse and a voltage limiter mutually welded, limiting transient voltage in 50/60 Hz circuits, and protecting an electronic circuit against surge voltages, inrush currents and the resulting over-temperatures.

2. Description of the Related Art

To protect against surge voltages, existing electronic circuits normally employ a protective component having a voltage-limiting function, such as metal oxide varistor (MOV). When a small or moderate voltage is applied across the MOV, only a tiny current flows, caused by reverse leakage through the diode junctions. When a large voltage is applied, the diode junction breaks down due to a combination of thermionic emission and electron tunneling, and a large current flow. Therefore, the large current flow is absorbed by the MOV and not passed to the electronic circuits. The MOV is triggered or destroyed when a transient pulse applied across the MOV exceeds an absolute maximum rating thereof, a maximum energy. With reference to FIG. 9, such MOV is parallelly connected to an electronic circuit (91). As a result, the electronic circuit (91) remains unprotected against new surges after triggering of the MOV (90) until replacement of the triggered component. Since the MOV (90) is mounted between Line (L) and Neutral (N), it is subjected to the full surge, current and energy. Furthermore, as the MOV is also subjected to sustained over-voltage, the risk of overstressing the MOV exists and may lead to a thermal runaway or degradation of the MOV, causing the surge protective device to heat up or explode. In addition to the issue of being unprotected against new surges after triggering and before replacement of the MOV and the exploding risk, the conventional surge protective devices end up with either higher cost or bulky size.

### SUMMARY OF THE INVENTION

An objective of the present invention is to provide a circuit protective device limiting transient voltage in 50/60 Hz circuits and protecting an electronic circuit against surge voltages, inrush currents and the resulting over-temperatures with two disconnection means.

To achieve the foregoing objective, the circuit protective device has an input live line, an input neutral line, an output live line, an output neutral line, a wire-wound resistor, a fuse and a voltage limiter.

The input live line and the input neutral line are adapted to connect to an AC outlet. The output live line and the output neutral line are adapted to connect to an electronic circuit. The wire-wound resistor has two ends. One of which is connected with the input live line. The fuse has a first end and a second end. The first end is connected with the other end of the wire-wound resistor.

The voltage limiter has a first lead and a second lead. The first lead is connected with the second end of the fuse and the output live line. The second lead is connected with the input neutral line and the output neutral line.

The voltage limiter clamps an incoming transient voltage applied across the input live line and the input neutral line to a specified level within a rating of the voltage limiter, the wire-wound resistor withstands the incoming transient voltage and reduces a surge current through the voltage limiter, and melts down to disconnect the electronic circuit from the AC outlet when a temperature of the wire-wound resistor exceeds a threshold value due to the fact that the incoming transient voltage is higher than a specified surge voltage withstanding rating of the wire-wound resistor, the fuse closely abuts the wire-wound resistor and the voltage limiter and disconnects the electronic circuit from the AC outlet when either the wire-wound resistor or the voltage limiter is overheated above a functioning open temperature of the fuse.

The wire-wound resistor reduces the surge current through the voltage limiter to allow selection of a voltage limiter having smaller size and more inexpensive price, thereby lowering the cost and size of the voltage limiter. The fuse and the wire-wound resistor serve as two protective means to disconnect the electronic circuit from the AC outlet when the wire-wound resistor or the voltage limiter is overheated. Accordingly, the circuit protective device addresses a cost-saving, compact and doubly-protected solution against surges and sustained voltages to the electronic circuit.

### BRIEF DESCRIPTION OF THE DRAWINGS

FIG. 1 is a circuit block diagram of a first embodiment of a circuit protective device in accordance with the present invention;

FIG. 2 is a circuit block diagram of a second embodiment of a circuit protective device in accordance with the present invention; and

FIG. 3 is a circuit block diagram of a third embodiment of a circuit protective device in accordance with the present invention;

FIG. 4 is a circuit block diagram of a fourth embodiment of a circuit protective device in accordance with the present invention;

FIG. 5 is a circuit block diagram of a fifth embodiment of a circuit protective device in accordance with the present invention;

FIG. 6 is a circuit block diagram of a sixth embodiment of a circuit protective device in accordance with the present invention;

FIG. 7 is a schematic diagram of a circuit protective device in accordance with the present invention, covered by a protective housing;

FIG. 8 is another schematic diagram of a circuit protective device in accordance with the present invention, covered by a protective housing; and

FIG. 9 is a circuit block diagram of a conventional surge protective device.

### DETAILED DESCRIPTION OF THE INVENTION

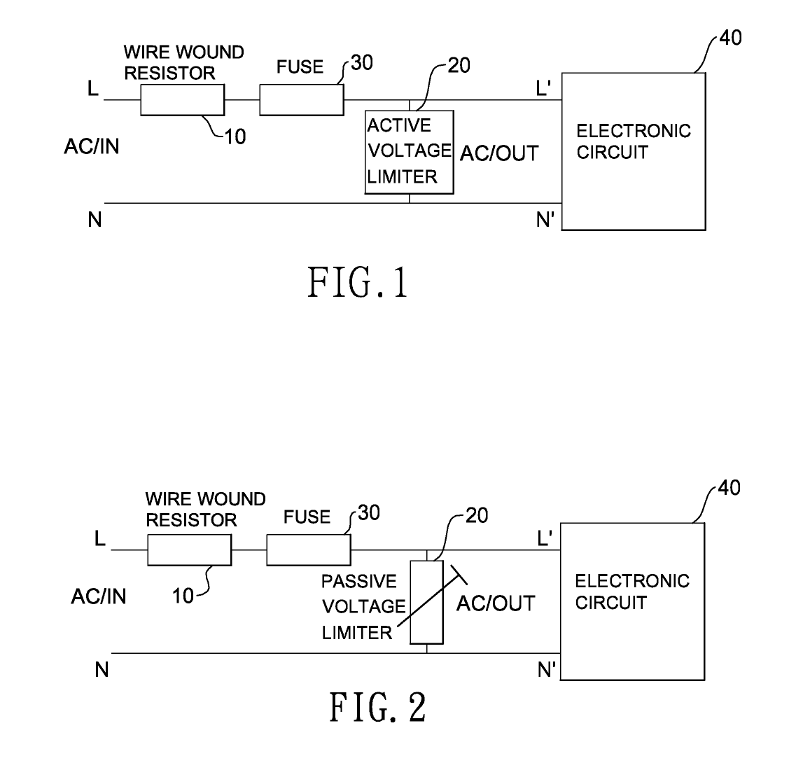

With reference to FIGS. 1 and 2, each of a first and a second embodiments of a circuit protective device in accordance with the present invention has an input live line (L), an input neutral line (N), an output live line (L′), an output neutral line (N′), a wire-wound resistor (10), a fuse (30) and a voltage limiter (20, 20′).

The input live line (L) and the input neutral line (N) are connected to an AC outlet. The output live line (L′) and the output neutral line (N′) are connected to an electronic circuit (40). The electronic circuit may operate at 50 Hz or 60 Hz. The wire-wound resistor (10) has one end connected with the input live line (L). The fuse (30) has one end connected with the other end of the wire-wound resistor (10). The voltage limiter (20, 20′) clamps an incoming transient voltage applied across the input live line (L) and the input neutral line (N) to a specified level (e.g. to 1000V) within its rating, and has a first lead and a second lead. The first lead is connected with the other end of the fuse (30) and the output live line (L′). The second lead is connected with the input neutral line (N) and the output neutral line (N′).

The wire-wound resistor (10) is designed to withstand the incoming transient voltage applied across the input live line (L) and the input neutral line (N) and reduces a surge current through the voltage limiter, and melts down to disconnect the electronic circuit (40) from the AC outlet when a temperature of the wire-wound resistor (10) exceeds a threshold value (about 1000° C.) due to the fact that the incoming transient voltage applied across the input live line (L) and the input neutral line (N) is higher than its specified surge voltage withstanding rating (e.g. 6 kV). When an over-temperature condition occurs arising from the incoming transient voltage over the specified surge voltage withstanding rating of the wire-wound resistor (10), a hot spot may occur inside the wire-wound resistor (10). If the temperature of the hot spot caused by the transient voltage reaches the threshold value, such as 1000° C. for a short time (in μ-second range), the wire-wound resistor (10) melts down and almost no current (in μ-ampere range) can go into the electronic circuit (40). Therefore, the electronic circuit (40) is disconnected from the AC outlet and is protected against subsequent surges.

The voltage limiter (20, 20′) in the first embodiment is an active component, such as a thyristor, a zener diode or a MOSFET (metal oxide semiconductor field effect transistor), or a passive component in the second embodiment, such as an MOV.

The fuse (30) disconnects when a leakage current of the voltage limiter (20, 20′) causes a temperature exceeding a functioning open temperature (e.g. 260° C.) of the fuse, or when the temperature of the wire-wound resistor is below the threshold-value (about 1000° C.) but exceeding the functioning open temperature of the fuse (30). The fuse (30) may be a thermal fuse, a thermal element, a thermal cutoff or a thermal link. The fuse (30) targets at offering a quick thermal response to an over-temperature condition from the wire-wound resistor or the voltage-limiter. The quick disconnection of the fuse (30) relieves the voltage limiter (20, 20′) of the risk of aging and degradation causing thermal runaway and explosion of the voltage limiter (20, 20′). Furthermore, as the fuse (30) closely abuts the wire-wound resistor (10) and the voltage limiter (20, 20′), a single fuse (30) is required only and can be disconnected by the heat generated from the wire-wound resistor (10) or the voltage limiter (20, 20′).

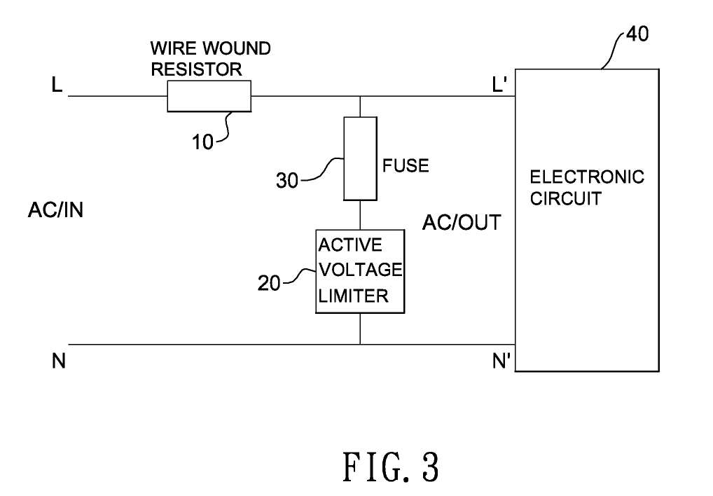

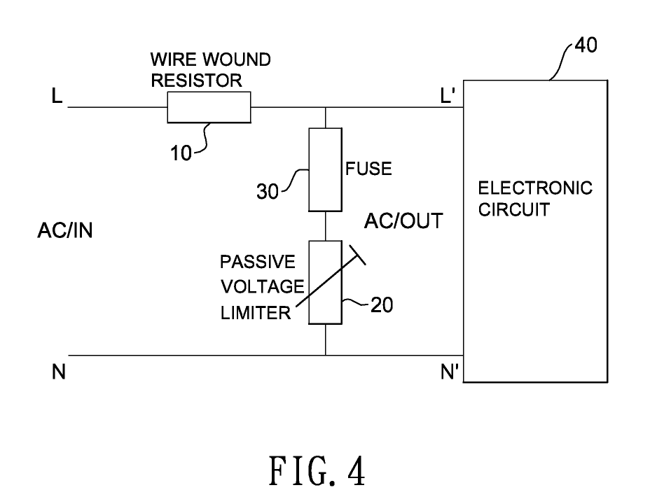

With reference to FIGS. 3 and 4, each of a third and a fourth embodiments of a circuit protective device in accordance with the present invention has an input live line (L), an input neutral line (N), an output live line (L′), an output neutral line (N′), a wire-wound resistor (10), a fuse (30) and a voltage limiter (20, 20′). The input live line (L) and the input neutral line (N) are connected to an AC outlet. The output live line (L′) and the output neutral line (N′) are connected to an electronic circuit (40). The electronic circuit may operate at 50 Hz or 60 Hz. The wire-wound resistor (10) has one end connected with the input live line (L). The fuse (30) has one end connected with the other end of the wire-wound resistor (10) and the output live line (L′). The voltage limiter (20, 20′) clamps an incoming transient voltage applied across the input live line (L) and the input neutral line (N) to a specified level (e.g. to 1000V) within its rating, and has a first lead and a second lead. The first lead is connected with the other end of the fuse (30). The second lead is connected with the input neutral line (N) and the output neutral line (N′).

The wire-wound resistor (10) is designed to withstand the incoming transient voltage applied across the input live line (L) and the input neutral line (N) and reduces a surge current through the voltage-limiter, and melts down to disconnect from the electronic circuit (40) when a temperature of the wire-wound resistor (10) exceeds a threshold value, such as 1000° C., for a short time (in μ-second range) due to the fact that the incoming transient voltage between the input live line (L) and the input neutral line (N) is higher than its specified surge-voltage withstanding rating (e.g. 6 kV).

The voltage limiter (20, 20′) in the third embodiment is an active component, such as a thyristor, a zener diode or a MOSFET, or a passive component in the fourth embodiment, such as an MOV.

The fuse (30) closely abuts the wire-wound resistor (10) and the voltage limiter (20, 20′), and serves to disconnect the voltage limiter (20, 20′) from the AC outlet when either the wire-wound resistor (10) or the voltage limiter (20, 20′) is overheated above the functioning open temperature of the fuse (30). The fuse (30) may be a thermal fuse, a thermal element, a thermal cutoff or a thermal link.

The third and fourth embodiments differ from the first and second embodiments in that during the overstressing condition the fuse (30) disconnects to protect the electronic circuit and the voltage limiter (20, 20′) in the first and second embodiments while the fuse (30) disconnects to protect the voltage limiter (20, 20′) only in the third and fourth embodiments.

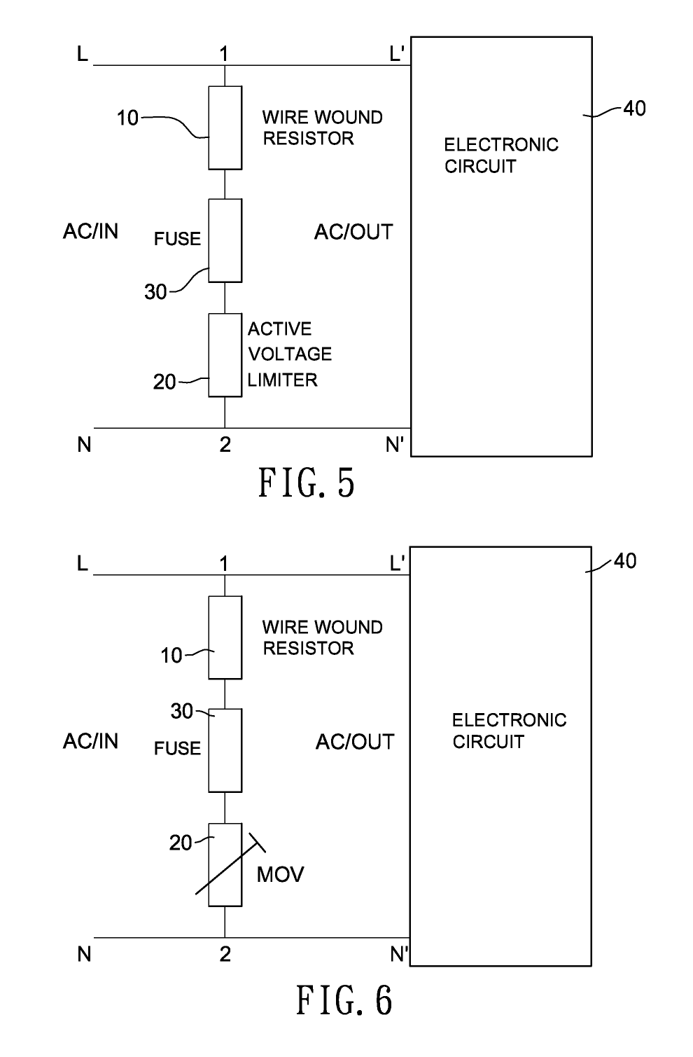

With reference to FIGS. 5 and 6, each of a fifth and a sixth embodiments of a circuit protective device in accordance with the present invention has an input live line (L), an input neutral line (N), an output live line (L′), an output neutral line (N′), a wire-wound resistor (10), a fuse (30) and a voltage limiter (20, 20′). The input live line (L) and the input neutral line (N) are connected to an AC outlet. The output live line (L′) and the output neutral line (N′) are connected to an electronic circuit (40). The electronic circuit may operate at 50 Hz or 60 Hz. The wire-wound resistor (10) has one end connected with the input live line (L) and the output live line (L′). The fuse (30) has one end connected with the other end of the wire-wound resistor (10). The voltage limiter (20, 20′) clamps an incoming transient voltage applied across the input live line (L) and the input neutral line (N) to a specified level (e.g. to 1000V) within its rating and has a first lead and a second lead. The first lead is connected with the other end of the fuse (30). The second lead is connected with the input neutral line (N) and the output neutral line (N′).

The resistance-value of the wire-wound resistor has to be chosen depending on the impedance of the electronic circuit, in order to avoid a malfunction of the Voltage-Limiter.

The wire-wound resistor (10) is designed to withstand the incoming transient voltage applied across the input live line (L) and the input neutral line (N) and slightly reduces the surge current through the voltage-limiter, and melts down to disconnect with the fuse (30) and the voltage limiter (20, 20′) when a temperature of the wire-wound resistor (10) exceeds a threshold value, such as 1000° C., for a short time (in μ-second range) due to the fact that the incoming transient voltage applied across the input live line (L) and the input neutral line (N) is higher than its specified surge voltage withstanding rating (e.g. 6 kV).

The voltage limiter (20, 20′) in the fifth embodiment is an active component, such as a thyristor, a zener diode or a MOSFET, or a passive component in the sixth embodiment, such as an MOV.

The fuse (30) closely abuts the wire-wound resistor (10) and the voltage limiter (20, 20′), and serves to disconnect with the voltage limiter (20, 20′) and with wire-wound resistor when the wire-wound resistor (10) or the voltage limiter (20, 20′) is overheated above a functioning open temperature of the fuse (30). The fuse (30) may be a thermal fuse, a thermal element, a thermal cutoff or a thermal link.

Instead of safely disconnecting the electronic circuit (40) from the AC mains, the purpose of the fifth and sixth embodiments aims at protecting the voltage limiter (20, 20′) only. In case of subsequent surge above the specification of this device, the electronic circuit will not be disconnected from the mains.

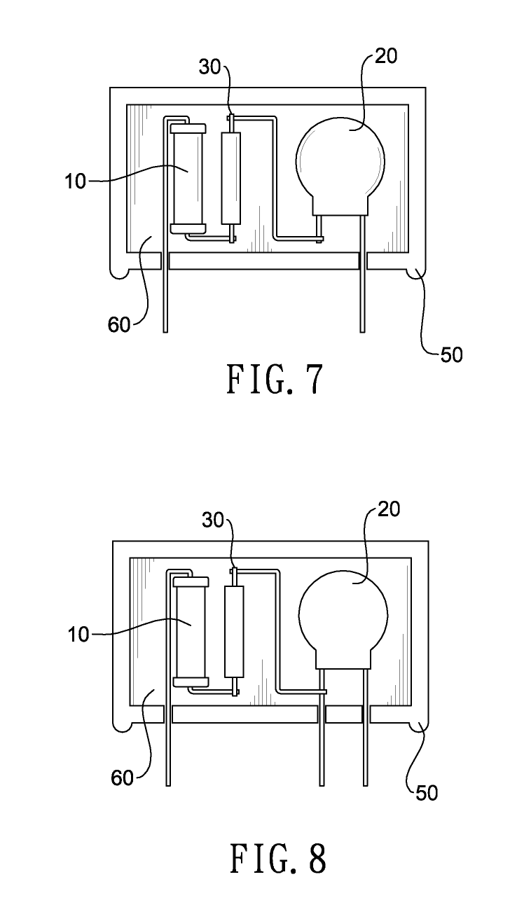

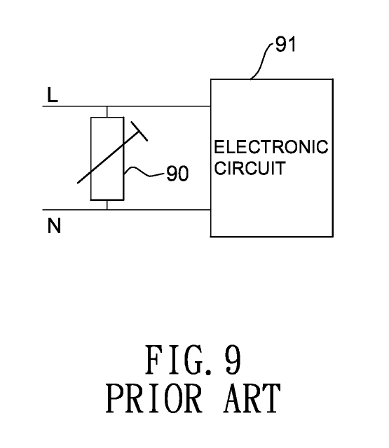

With reference to FIG. 7, a single resistor (or more) (10), a fuse (30) and a voltage limiter (20) are connected serially by welding and covered by a protective housing (50). With reference to FIG. 8, a single resistor (or more) (10) and a fuse (30) are connected serially and are connected in parallel once to the voltage-limiter by welding and also to the electronic circuit. All the components (10, 20, 30) are covered by a protective housing (50) which is filled with a filling material (60) to protect the welding points of the embedded components, to distribute the temperature equally inside the housing (10, 20, 30), and in a surge event to prevent an explosion within a specified range of surge voltage. The protective housing may be made of ceramic, plastic or the like. The filling material may be cement, epoxy, resin or the like.

In contrast to conventional surge protective device equipped with a MOV, in a surge-event the wire-wound resistor reduces the current which goes through the voltage limiter, and the energy-load on the voltage limiter can be further reduced. Therefore, the wire-wound resistor relaxes the specification of the voltage limiter, and smaller size of the voltage limiter is allowed. Besides, the wire-wound resistor and the fuse serving as two disconnection means disconnect the electronic circuit from the AC mains and protect the electronic circuit against subsequent surges and sustained over-voltages (only applicable in FIGS. 1 to 4). Due to close proximity to the wire-wound resistor and the voltage limiter, the fuse is disconnected by heat either transferred from the wire-wound resistor or the voltage limiter, so only one fuse is needed. Disconnection done by the fuse prevents the voltage limiter from being overheated and the chances of thermal runaway. Moreover, given the accurate surge-voltage withstanding behavior of the wire-wound resistor, the temperature-protection provided by the thermal fuse to the resistor and the voltage limiter, and the protective housing covering the involved components, the present invention triggers without explosion, noise or light-arc for a surge in a specified range above the specification of the present invention. Accordingly, the circuit protective device of the present invention addresses a cost-saving, compact, doubly-protected and safe solution against surges and sustained voltages (only applicable in FIGS. 1 to 4) for an electronic circuit. Furthermore, if the embodiments are selected as shown in FIGS. 1,2,3 and 4, the present invention offers the option that the electronics will be disconnected safely from the mains in case of a surge-event higher than specified.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A circuit protective device, comprising:
an input live line and an input neutral line adapted to connect to an AC outlet;
an output live line and an output neutral line adapted to connect to an electronic circuit;
a wire-wound resistor having two ends, one of which is connected with the input live line;
a fuse having two ends, one of which is connected with the other end of the wire-wound resistor; and
a voltage limiter having:
a first lead connected with the other end of the fuse and the output live line; and
a second lead connected with the input neutral line and the output neutral line;
wherein the voltage limiter clamps an incoming transient voltage applied across the input live line and the input neutral line to a specified level within a rating of the voltage limiter, the wire-wound resistor withstands the incoming transient voltage and reduces a surge current through the voltage limiter, and melts down to disconnect the electronic circuit from the AC outlet when a temperature of the wire-wound resistor exceeds a threshold value due to the fact that the incoming transient voltage is higher than a specified surge voltage withstanding rating of the wire-wound resistor, the fuse closely abuts the wire-wound resistor and the voltage limiter and disconnects the electronic circuit from the AC outlet when either the wire-wound resistor or the voltage limiter is overheated above a functioning open temperature of the fuse.

2. The circuit protective device as claimed in claim 1, wherein the voltage limiter is a passive component.

3. The circuit protective device as claimed in claim 2, wherein the voltage limiter is a metal oxide varistor.

4. The circuit protective device as claimed in claim 1, wherein the voltage limiter is an active component.

5. The circuit protective device as claimed in claim 4, wherein the voltage limiter is a zener diode, a thyristor or a MOSFET in avalanche mode.

6. The circuit protective device as claimed in claim 1, wherein the fuse is a thermal fuse, a thermal element, a thermal cutoff or a thermal link.

7. The circuit protective device as claimed in claim 1, further comprising a protective housing covering the wire-wound resistor, the fuse and the voltage limiter, and filled with a filling material.

8. The circuit protective device as claimed in claim 7, wherein the protective housing is made of ceramic or plastic.

9. The circuit protective device as claimed in claim 7, wherein the filling material is cement, epoxy or resin.

10. A circuit protective device, comprising:
an input live line and an input neutral line adapted to connect to an AC outlet;
an output live line and an output neutral line adapted to connect to an electronic circuit;
a wire-wound resistor having two ends, one of which is connected with the input live line;
a fuse having two ends, one of which is connected with the other end of the wire-wound resistor and the output live line; and
a voltage limiter having:
a first lead connected with the other end of the fuse; and
a second lead connected with the input neutral line and the output neutral line;
wherein the voltage limiter clamps an incoming transient voltage applied across the input live line and the input neutral line to a specified level within a rating of the voltage limiter, the wire-wound resistor withstands the incoming transient voltage and reduces a surge current through the voltage limiter, and melts down to disconnect the electronic circuit from the AC outlet when a temperature of the wire-wound resistor exceeds a threshold value due to the fact that the incoming transient voltage is higher than a specified surge voltage withstanding rating of the wire-wound resistor, the fuse closely abuts the wire-wound resistor and the voltage limiter and disconnects the voltage limiter from the AC outlet when either the wire-wound resistor or the voltage limiter is overheated above a functioning open temperature of the fuse.

11. The circuit protective device as claimed in claim 10, wherein the voltage limiter is a passive component.

12. The circuit protective device as claimed in claim 11, wherein the voltage limiter is a metal oxide varistor.

13. The circuit protective device as claimed in claim 10, wherein the voltage limiter is an active component.

14. The circuit protective device as claimed in claim 13, wherein the voltage limiter is a zener diode, a thyristor or a MOSFET in avalanche mode.

15. The circuit protective device as claimed in claim 10, wherein the fuse is a thermal fuse, a thermal element, a thermal cutoff or a thermal link.

16. The circuit protective device as claimed in claim 10, further comprising a protective housing covering the wire-wound resistor, the fuse and the voltage limiter, and filled with a filling material.

17. The circuit protective device as claimed in claim 16, wherein the protective housing is made of ceramic or plastic.

18. The circuit protective device as claimed in claim 16, wherein the filling material is cement, epoxy or resin.

19. A circuit protective device, comprising:
an input live line and an input neutral line adapted to connect to an AC outlet;
an output live line and an output neutral line adapted to connect to an electronic circuit;
a wire-wound resistor having one end connected with the input live line and the output live line;
a fuse having one end connected with the other end of the wire-wound resistor; and
a voltage limiter having:
a first lead connected with the other end of the fuse; and
a second lead connected with the input neutral line and the output neutral line.
wherein the voltage limiter clamps an incoming transient voltage applied across the input live line and the input neutral line to a specified level within a rating of the voltage limiter, the wire-wound resistor withstands the incoming transient voltage and reduce a surge current through the voltage-limiter, and melts down to disconnect the voltage limiter from the AC outlet when a temperature of the wire-wound resistor exceeds a threshold value due to the fact that the incoming transient voltage is higher than a specified surge voltage withstanding rating of the wire-wound resistor, the fuse closely abuts the wire-wound resistor and the voltage limiter and disconnects the voltage limiter from the AC outlet when either the wire-wound resistor or the voltage limiter is overheated above a functioning open temperature of the fuse.

20. The circuit protective device as claimed in claim 19, wherein the voltage limiter is a passive component.

21. The circuit protective device as claimed in claim 20, wherein the voltage limiter is a metal oxide varistor.

22. The circuit protective device as claimed in claim 19, wherein the voltage limiter is an active component.

23. The circuit protective device as claimed in claim 22, wherein the voltage limiter is a zener diode, a thyristor or a MOSFET in avalanche mode.

24. The circuit protective device as claimed in claim 19, wherein the fuse is a thermal fuse, a thermal element, a thermal cutoff or a thermal link.

25. The circuit protective device as claimed in claim 19, further comprising a protective housing covering the wire-wound resistor, the fuse and the voltage limiter, and filled with a filling material.

26. The circuit protective device as claimed in claim 25, wherein the protective housing is made of ceramic or plastic.

27. The circuit protective device as claimed in claim 25, wherein the filling material is cement, epoxy or resin.
